(19) United States
(12) Patent Application Publication
(10) Pub. No.: US 2004/0190210 A1
(43) Pub. Date: Sep. 30, 2004

(54) Memory back up and content preservation

(76) Inventor: Brian A. Leete, Beaverton, OR (US)

Correspondence Address: Blakely Sokoloff Taylor & Zafman, Seventh Floor, 12400 Wilshire Boulevard, Los Angeles, CA, 90025-1030, US

(21) Appl. No.: 10/397,726

(22) Filed: Mar. 26, 2003

(51) Int. Cl. H02H 3/20

(52) U.S. Cl. 361/90

(57) ABSTRACT

A system, apparatus, and method are provided for memory backup and content preservation. According to one embodiment, a first memory bank of a memory, which is coupled to a computer bus, is reserved for a private use, and an isolation circuitry, which is coupled to the first memory bank, isolates the first memory bank from the computer bus in response to a signal indicating power failure received from and detected by a power failure/reduction detection unit, which is coupled to the isolation circuitry.

### BACKGROUND OF THE INVENTION

1. Field of the Invention

This invention relates generally to computer memory, and more particularly, to backing up the computer memory and preserving its content.

2. Description of the Related Art

Many attempts have been made to provide various reliable battery backup systems, as well as peripherals to power or retain and preserve contents of memory devices. For example, using a disk drive is a slow way to get the data in and out of a computer system. To increase the effective speed of the drive one can put a memory cache in from of the disk drive. This way, the system transfers data to the higher speed memory instead of the slower disk. The disk cache can be physically located in the system, or on the disk drive itself. However, one of the problems with caching data to a volatile memory is that the data is lost in case of the power failure. Despite many attempts to immune data from power failure, methods and apparatus available today do not teach dedicating disk cache from the operating system on the main memory itself.

FIG. 1 is a conventional PCI-based memory board. As illustrated, the computer system 100 includes a computer bus 102 coupled with the main memory 104 and the central processing unit (CPU) 106. The computer system 100 also includes an auxiliary bus 112, such as a peripheral component interconnect (PCI) bus, 112 coupled with the CPU 106 and the auxiliary memory 108. Finally, the computer system includes a battery backup unit 110 for providing power. As illustrated, in the computer system 100, caching of data destined for a disk is done on an auxiliary memory 108 sitting on an external (PCI) bus 112.

Conventional computer systems, such as computer system 100, rely on auxiliary memory solutions requiring additional hardware infrastructure and expense. For example, putting the memory on the PCI bus as opposed to putting the equivalent amount of memory on the main memory bus would require adding a memory controller to the PCI. Moreover, conventional computer systems do not provide for physically locating the disk cache on the main memory itself. Furthermore, such computer systems do not provide hybrid memory solutions, such as DRAM and supplemental nonvolatile memory technologies for caching, and do not disclose preserving memory when the cache is dirty and needs to be preserved.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram illustrating a conventional computer system;

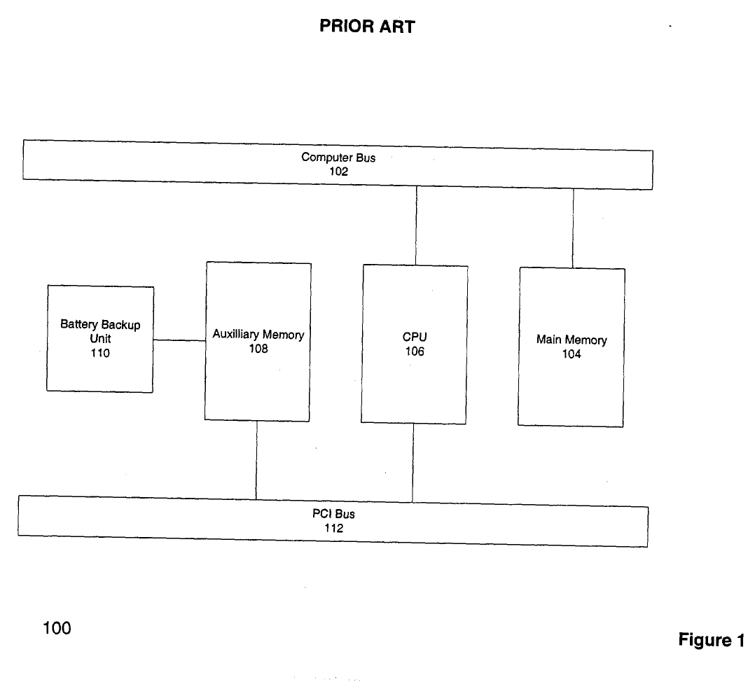

FIG. 2 is a block diagram conceptually illustrating a computer system on which embodiments of the present invention may be implemented, according to one embodiment;

FIG. 3 is a block diagram conceptually illustrating memory back up and content preservation, according to one embodiment;

FIG. 4 is a block diagram conceptually illustrating an overview of some of the software and hardware components relevant to reserving and dedicating a main memory bank, according to one embodiment;

FIG. 5 is a flow diagram conceptually illustrating a process of reserving a memory bank, according to one embodiment;

FIG. 6 is a flow diagram conceptually illustrating a process of memory back up and content preservation, according to one embodiment;

FIG. 7 is a block diagram conceptually illustrating memory back up and content preservation, according to one embodiment; and

FIG. 8 is a flow diagram conceptually illustrating memory back up and content preservation, according to one embodiment.

### DETAILED DESCRIPTION

A system and method for memory backup and content preservation are provided. Broadly stated, embodiments of the present invention allow for reserving a memory bank for private use and preserving memory contents on the memory bank; and, according to another embodiment, contents of the memory may be preserved using a supplemental storage mechanism.

According to one embodiment, memory is used to cache the disk, and flash and the battery to protect the contents of the memory in case of a power failure or reduction before the data can be flushed to the disk. According to a further embodiment, a memory bank, such as a dynamic random access memory (DRAM) dual in-line memory module (DIMM), is reserved from the operating system for private use of the disk caching driver, the main memory bank is isolated and its contents are preserved on the main memory bank. According to another embodiment, contents of the main memory bank are preserved using a supplemental storage mechanism.

According to one embodiment, a hardware mechanism is provided to battery back up a main memory slot on the motherboard, e.g., reserving and dedicating a memory bank, such as DRAM DIMM, on the motherboard from the operating system for disk cache using the Basic Input Output System (BIOS) E820 interface between the operating system and the hardware. In particular, according to one embodiment, BIOS and Advanced Configuration and Power Interface (ACPI) are used to reserve a memory, such as DRAM DIMM, from the operating system and to load a caching driver for the reserved memory bank for making the it the bank dedicated for private use. According to one embodiment, the private use includes a non-operating system use and may include using the memory bank for storing and/or caching of data to and/or from a disk drive, a network, or an I/O device.

According to one embodiment, memory may be battery backed up for preserving the data of interest over any power cycle. For example, the use of a dirty bit allows the hardware to determine whether there is data of interest to backup. The use of a dirty bit allows for power saving, as it may remove the necessity for continuously keeping the memory bank powered up in the absence of the data of interest.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

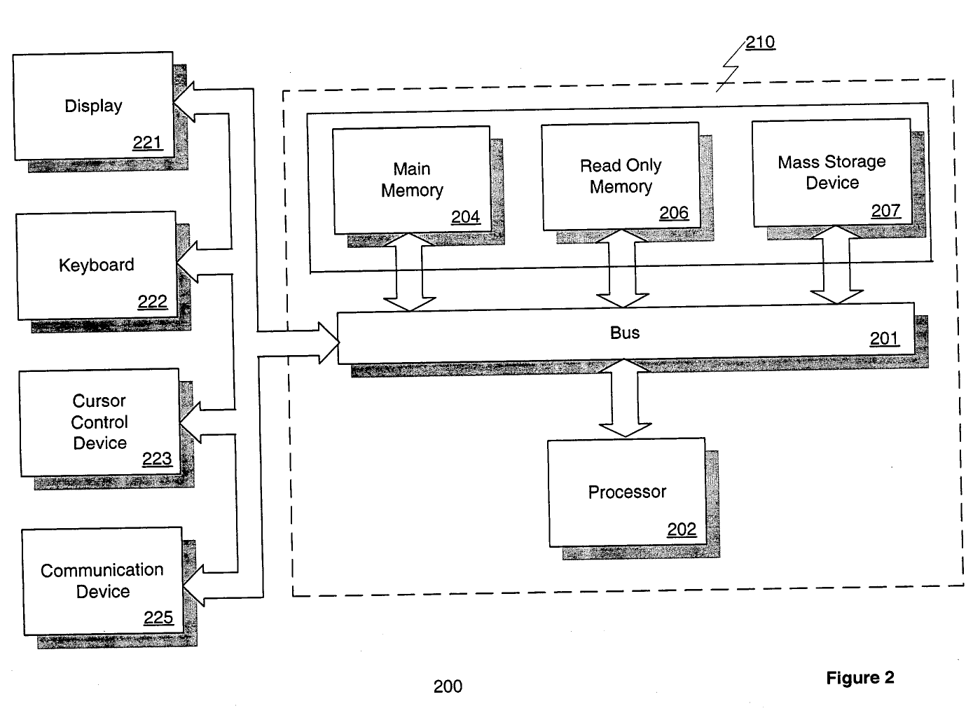

FIG. 2 is a block diagram conceptually illustrating a computer system on which embodiments of the present invention may be implemented, according to one embodiment. Computer system 200 includes a bus or other communication means 201 for communicating information, and a processing means such as processor 202 coupled with bus 201 for processing information. Computer system 200 further includes a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. Computer system 200 also includes a read only memory (ROM) and/or other static storage device 206 coupled to bus 201 for storing static information and instructions for processor 202.

A data storage device 207 such as a magnetic disk or optical disc and its corresponding drive may also be coupled to computer system 200 for storing information and instructions. Computer system 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and command selections to processor 202 and for controlling cursor movement on display 221.

A communication device 225 is also coupled to bus 201. The communication device 225 may include a modem, a network interface card, or other well-known interface devices, such as those used for coupling to Ethernet, token ring, or other types of physical attachment for purposes of providing a communication link to support a local or wide area network, for example. In this manner, the computer system 200 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 200 will vary from implementation to implementation depending upon numerous factors, such as price constraints, performance requirements, technological improvements, and/or other circumstances.

It should be noted that, while the steps described herein may be performed under the control of a programmed processor, such as processor 202, in alternative embodiments, the steps may be fully or partially implemented by any programmable or hard-coded logic, such as Field Programmable Gate Arrays (FPGAs), transistor-transistor logic (TTL) logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

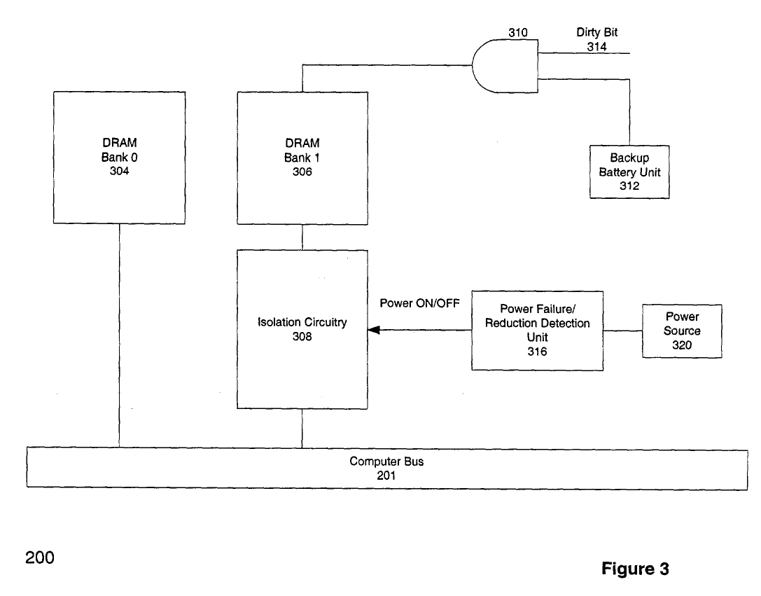

FIG. 3 is a block diagram conceptually illustrating memory back up and content preservation, according to one embodiment. As illustrated, a computer system 200 includes a computer bus 201, memory, such as dynamic random access memory (DRAM) 304, 306 having two banks, bank 0 304 and bank 1 306, an isolation circuitry 308, backup battery unit 312, and a power failure/reduction detection unit 316. With regard to memory 304 and 306, any variety of memory mechanisms, memory technologies, memory apparatus, and memory systems are contemplated, including DRAM, which is used as an example in FIG. 3, and anywhere else in this application, for illustration purposes only.

According to one embodiment, the computer bus 201 may be a typical system bus, also known as internal bus, local bus, processor bus, or memory bus. The computer bus 201 may be coupled with memory DRAM 304 and 306 and provide a data transfer path between the central processing unit (CPU) of the computer system 200 and memory DRAM 304 and 306 and other applications, peripherals, and buses. A typical computer bus 201 may include an address bus to send addresses to signal a memory location, and a data bus to transfer data to that memory location. Examples of various personal computer (PC) buses include Industry Standard Architecture (ISA), Extended ISA (EISA), Accelerated Graphics Port (AGP) bus, Micro Channel, VESA Local Bus (VL-bus), and Peripheral Component Interconnect (PCI) bus. Examples of peripheral buses include NuBus, TURBOchannel, Virtual Machine Environment bus (VMEbus), and MULTIBUS.

According to one embodiment, a socket of the motherboard may be used to battery backup the memory 304 and 306 on the motherboard. For example, an arrangement of Dual In-line Memory Module (DIMM) socket may be used in case of a desktop or a Small Outline DIMM (SODIMM) socket may be used in case of a laptop to battery back up the main memory, as DIMMs are typically used in desktop computers and servers, while SODIMMs are used in laptops.

A DIMM or SODIMM socket typically includes several pins in a certain arrangement with pin numbers. Some of the earlier model computers may include Single In-line Memory Modules (SIMM). Some of the DIMMs may include a 168-in DIMM (FPM, EDO, SDRAM), a 184-pin DIMM (DDR, SDRAM), and a 184-pin RDRAM (Rambus) where the chips may be covered with a metal heat sink. Some of the SODIMM may include a 72-pin SODIMM (FPM, EDO), a 144-pin SODIMM (FPM, EDO, SDRAM), and a 200-pin SODIMM (DDR, SDRAM). Some of the SIMMs may include a 30-pin SIMM (DRAM) and 72-pin SIMM (FPM).

The embodiments of the present invention may be achieved by using a single DIMM or SODIMM slot without adding more hardware or changing the physical or circuit components of a computer system, such as computer system 200. DRAM DIMMS are used as memory bank 0, 1 304 and 306 in FIG. 3 and anywhere else in this application as examples and for illustration purposes only. However, certain changes in the hardware and components of a computer system are contemplated to achieve varying results.

Typically, the memory, main or auxiliary, are controlled by the operating system (OS) of a computer system 200. According to one embodiment, DRAM 304, 306 may be divided into banks, such as bank 0 304, dedicated for the operating system use, and bank 1 306, dedicated for private, non-operating system use. The private, non-operating use may include storing and caching data to and from a disk drive, network, or input/output (I/O) device. Stated differently, the reserved or dedicated memory bank 1 306 may be used for storing and caching data to and from a disk drive, network, or I/O device.

According to one embodiment, in case of power failure or reduction below a certain threshold level, the power failure/reduction detection unit 316 may detect and issue the power failure to the isolation circuitry 308. According to one embodiment, the isolation circuitry 308 may include or be coupled with a cache controller. The isolation circuitry 308, according to one embodiment, may be independent circuitry or part of the system 200. The isolation circuitry 308 may be part of a chipset of the system 200. Examples of a chipset may include various Intel chipsets having a set of chips to provide the interfaces between all of the system's 200 subsystems, and having buses and electronics to allow the CPU, memory, and input/output devices to interact. Upon detection of the power failure, DRAM bank 1 306, that is reserved for private use, may be isolated from the computer bus 201 by the isolation circuitry 308, while DRAM bank 1 306 is kept powered up by a backup battery unit 312.

According to one embodiment, the backup battery unit 312 may be an auxiliary battery backup unit 312, in case of a desktop computer system 200, or an internal battery unit 312, in case of a laptop computer system 200. The nature of the battery unit 312 may also depend on the capabilities of the computer system 200 and various other factors. A variety of batteries, power sources, battery mechanisms, battery apparatus, and battery systems are contemplated. Some of the popular examples of rechargeable batteries are lead acid, nickel cadmium, nickel metal hydride, lithium ion, lithium polymer, zinc air, memory effect, or such. For example, according to one embodiment, the backup battery unit 312 may include a set of capacitors for continuously powering the DRAM bank 1 306, a battery commonly used in laptops that is linked with the systems, or a standalone battery with the system 200 having a circuitry to switch from the power source 320 to the standalone backup battery unit 312, or such, or a combination thereof.

According to one embodiment, DRAM DIMM/bank 1 306 may be continuously powered by the backup battery unit 312 and the memory data or contents may be preserved on the DRAM bank 1 306 by, for example, advancing DRAM bank 1 306 into a continuous self-refresh mode. According to one embodiment, using a cache dirty bit, the data of interest may be preserved and the power may be turned off in case there is no data of interest to avoid a waste of power. A cache dirty bit 314 may be exported using software to control determine whether power may to applied to the DRAM DIMM/bank 1 306 while the rest of the computer system 200 is off. An AND gate 310 may be used with regard to the dirty bit 314.

According to one embodiment, in the absence of dirty cache, the power to the DRAM DIMM/bank 1 306 may be turned off to prevent unnecessary power usage and drain on the backup battery unit 312, while, on the other hand, in case of dirty cache, the power may be continuously supplied to the DRAM DIMM/bank 1 306 to preserve its data. According to one embodiment, in case of an unexpected power failure, the dirty bit is set and the DRAM DIMM/bank 1 306 is backed up directly from the backup battery unit 312 regardless of the power state of the computer system 200 to avoid any loss of data, until it is determined whether power should be kept on.

According to one embodiment, Basic Input Output System (BIOS) may use an interface, such as an E820 interface, to mark DRAM bank 1 306 as reserved by informing the operating system (OS) about the DRAM bank 1 306 being present, but not available for use by the OS. According to one embodiment, BIOS may test and prepare the computer system 200 for operation by observing and querying its components, such as memory banks, including DRAM banks 0 and 1 304, 306, and other configuration settings.

BIOS, typically, loads the OS and passes control to the OS as it accepts various requests from drivers and application programs. According to one embodiment, BIOS, while observing and querying the components of the computer system 200, may observe and locate the dedicated DRAM bank 1 306 as being present, but not available for use by the OS. BIOS may then inform the OS that DRAM bank 1 306 is present, but it 306 is not available for use by the OS. As stated earlier, memory banks 0 and 1 304, 306 may be DRAM DIMMS. Furthermore, BIOS may not alter the contents of the memory 304, 306 during boot up and post-boot up phases, and may provide a user setting to allow the user to put the memory DRAM bank 1 306 into such a mode. Typically, BIOS may include a set of routines of the computer system 200 which may be stored on a chip, to provide an interface between the OS and the hardware of the computer system 200. BIOS may also support numerous applications, components, and peripheral technologies and internal services, such as the real-time clock.

) According to one embodiment, Advanced Configuration and Power Interface (ACPI) may mark and describe hardware of the main memory platform of the computer system 200 to the operating system. Stated differently, ACPI may mark and identify, for example, the physical address range corresponding to the memory DRAM bank 1 306 as a memory mapped Input/Output (10) device and may also define a hardware identification for it. According to one embodiment, the operating system of the computer system 200 may load a driver based on the hardware identification, received from ACPI, and may allocate memory resources to it. In doing so, DRAM DIMM/bank 1 306 may be reserved for private use and prevented from operating system control and use.

According to another embodiment, in case the BIOS indicate that the memory DRAM 306 is not present, ACPI may indicate to the OS that the memory DRAM 306 is present and ask the OS to load a driver for it, preserving the memory DRAM DIMM/bank 1 306 for private, non-OS use. According to one embodiment, the private use may include using the DRAM DIMM/bank 1 306 for storing and/or caching data to and/or from one or more of the following: a disk drive, a network, and an I/O device.

According to one embodiment, isolation circuitry 308 coupled with DRAM bank 1 306 may be provided to isolate DRAM bank 1 306 from the computer bus 201 and set it up so that, in case of a power failure, the DRAM bank 1 306 is powered up using a backup battery unit 312 and its data is preserved. The isolation circuitry 308 may be an independent circuitry or part of the chipset. Furthermore, the isolation circuitry 308 may be physically and/or logically coupled with or include a cache controller.

The isolation circuitry 308 may also be coupled with the power failure/reduction detection unit 316, which may be coupled with the power source 320, to receive the signal indicating power failure or reduction of power under a threshold level necessary to perform a particular task, necessities of a user or organization, capabilities of the system 200, or such, or the threshold level as set by a predetermined policy or criteria.

According to one embodiment, the power failure/reduction detection unit 316 may detect power failure form the power source 320 and issue the power failure to the isolation circuitry 308, so that the DRAM bank 1 306 may be isolated from the computer bus 201, continued to be powered using a backup battery unit 312, and memory contents may preserved on the DRAM bank 1 306.

According to one embodiment, any combination of the various components of the computer system 200 is contemplated, and may be used based on given circumstances and/or predetermined criteria or policy or necessities. It is also contemplated that not all the components are necessary, and several other components may be added, as it will be obvious to the one familiar with the art.

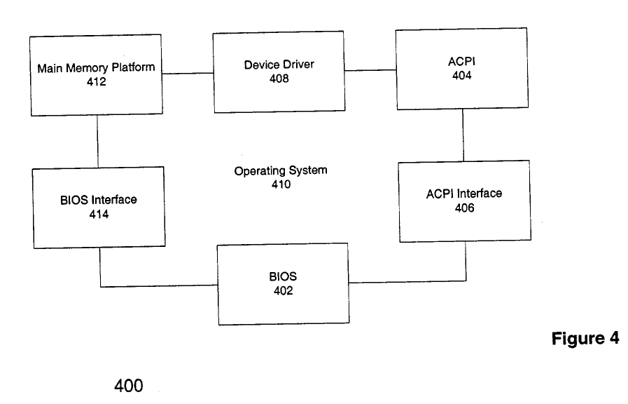

FIG. 4 is a block diagram conceptually illustrating an overview of some of the software and hardware components relevant to reserving and dedicating a memory bank, according to one embodiment. As illustrated, Basic Input Output System (BIOS) 402 interfaces with the memory platform 412 and with Advanced Configuration and Power Interface (ACPI) 404 via an ACPI interface 406, as well as with the operating system (OS) 410 of the computer system 400.

According one embodiment, BIOS 402 may use an interface 414, such as an E820 interface, to mark the memory bank on the memory platform 412 as reserved by informing the OS 410 that the bank is present, but it is not available for use by the operating system 410.

According to one embodiment, BIOS 402 may first test the computer system 400 and prepare it 400 for operation by observing and querying its main memory platform 412 and other configuration settings. According to one embodiment, the BIOS 402, when observing and querying the memory banks on the memory platform 412, observes where the dedicated memory DRAM DIMM is located and informs the OS that the DRAM DIMM is present, but it is not available for use by the OS 410. According to one embodiment, BIOS 402 does not alter memory contents during the boot up and post boot up phases. Furthermore, BIOS 402 may also provide a user setting that would allow the user to put DRAM DIMM on the main memory 412 into its mode.

According to one embodiment, ACPI 404 interfaces with the BIOS 402 using an ACPI interface 406, and interfaces with device driver 408 for the memory platform 412. ACPI 404, like BIOS 402, may also interface with various other applications and devices of the computer system 400. ACPI 404 may mark and describe the hardware of the memory platform 412 to the operating system 410. Stated differently, ACPI 404 may mark the physical address range corresponding to the DRAM DIMM on the memory platform 412 as a memory mapped input/output (IO) device and may define and assign a hardware identification (hardware ID) for it. According to one embodiment, the OS 410 of the computer system 400 may load a device driver 408 based on the hardware ID received from the ACPI 404, the may allocate memory resources, and so, the operating system 410 may be prevented from controlling and/or using the reserved or dedicated memory DRAM DIMM on the memory platform 412.

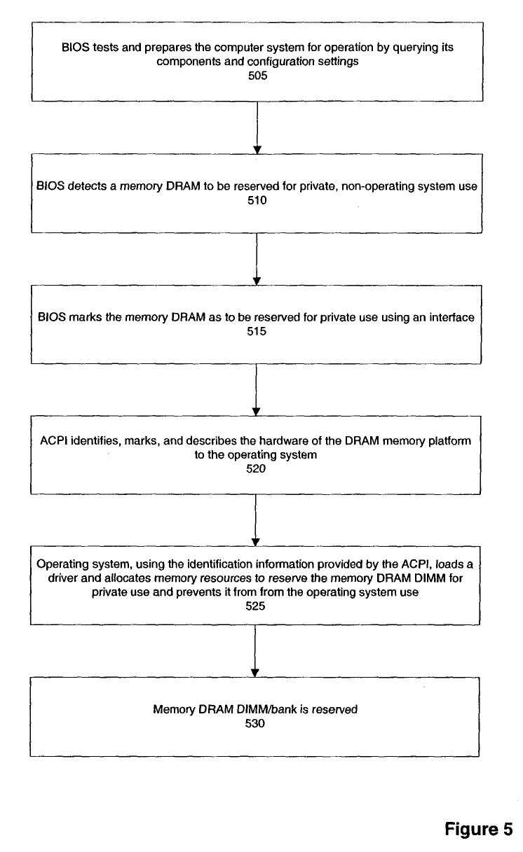

FIG. 5 is a flow diagram conceptually illustrating a process of reserving a memory bank, according to one embodiment. First, Basic Input Output System (BIOS) may test and prepare the computer system for operation by observing and querying its component, such as memory banks, and configuration settings at processing block 505. According to one embodiment, while observing and querying the memory banks of the computer system, BIOS observes and detects a memory bank, such as a DRAM DIMM, to be reserved for private, non-operating system use, at processing block 510. BIOS marks the memory DRAM DIMM reserved for private, non-operating system use using an interface, such as the E820 interface at processing block 515. The reserved DIMM of the memory DRAM may be considered, located, and marked present in the computer system, but it is marked unavailable for use by the operating system. Typically, the operating system of a computer system would control all memory for its use.

According to one embodiment, Advanced Configuration and Power Interface (ACPI) may identify, mark, and/or describe the hardware of the memory DRAM DIMM to the operating system at processing block 520. ACPI may mark the physical address range corresponding to the backed DRAM DIMM as a memory mapped input/output (IO) device and may define and provide a hardware identification for it.

According to one embodiment, the operating system of the computer, using the identification information provided by the ACPI, loads a device driver and allocates memory resources to it, and so, to mark the DRAM DIMM reserved and prevent the operating system from controlling and/or using the reserved DRAM DIMM at processing block 525. DRAM DIMM is reserved for private and non-operating system use including for storing and caching data to and from a disk drive, network, or I/O device at processing block 530

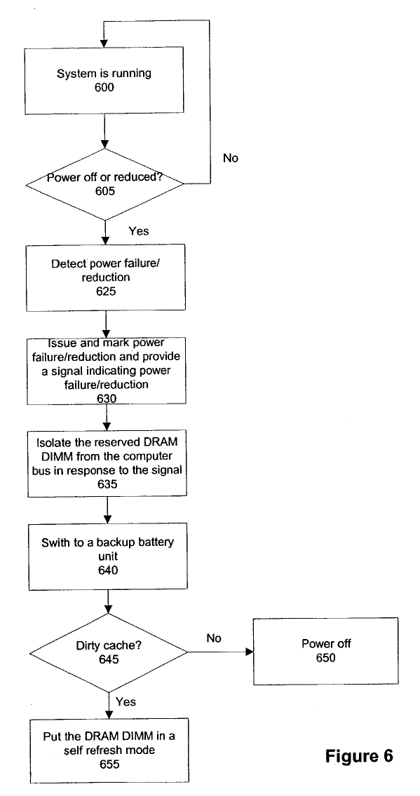

FIG. 6 is a flow diagram conceptually illustrating memory backup and content preservation, according to one embodiment. Prior to memory backup and content preservation, it may be determined whether the computer system is running. If the computer system is not running, there may not be a need for, for example, booting or to detect power off/reduction or to switch to a backup power source. First, the system is running at processing block 600. At decision block 605, it is determined whether the power is on or off or reduced. If the power is on and not reduced to an unacceptable or insufficient level, at decision block 610, the computer system functions normally.

According to one embodiment, if the power is off or is reduced to below a threshold level, the threshold level may be a level that is unacceptable or insufficient to perform a task or function or is based on a predetermined policy or criteria, the power failure is detected by the power failure/reduction detection unit from the power source at processing block 625. The power failure/reduction detection unit issues power failure and informs the isolation circuitry by providing a signal indicating power failure at 630. According to one embodiment, the isolation circuitry may be an independent circuitry or part of the chipset. The isolation circuitry isolates the reserved/dedicated DRAM DIMM from the computer bus upon detecting the signal indicating power failure at processing block 635.

According to one embodiment, a switch to a backup battery unit from the main power source is made to, for example, continue to power the DRAM DIMM at processing block 640. According to one embodiment, battery backup unit may be enabled not only even when power is completely shut off, but even when power may be insufficient or reduced. The backup battery unit may be internal as with laptop computer systems or auxiliary as with desktops. The battery backup unit may include a capacitor, a laptop battery, or a standalone battery, or such, or a combination thereof.

According to one embodiment, dirty cache is determined at decision block 645. If no dirty cache is determined, DRAM DIMM is powered off to prevent unnecessary use of power at processing block 650. However, if dirty cache is determined, according to one embodiment, power may continuously be supplied to the reserved/dedicated DRAM DIMM, and the DRAM DIMM may be put into a self-refresh mode at processing block 655. The continuous power supply to the DRAM DIMM and/or the self-refresh mode may help preserve the data on the main memory DRAM DIMM. According to one embodiment, all data or only the data of interest may be preserved. According to one embodiment, if the power is shut off or is not sufficient to maintain the self-refresh mode, another battery backup unit may be enabled.

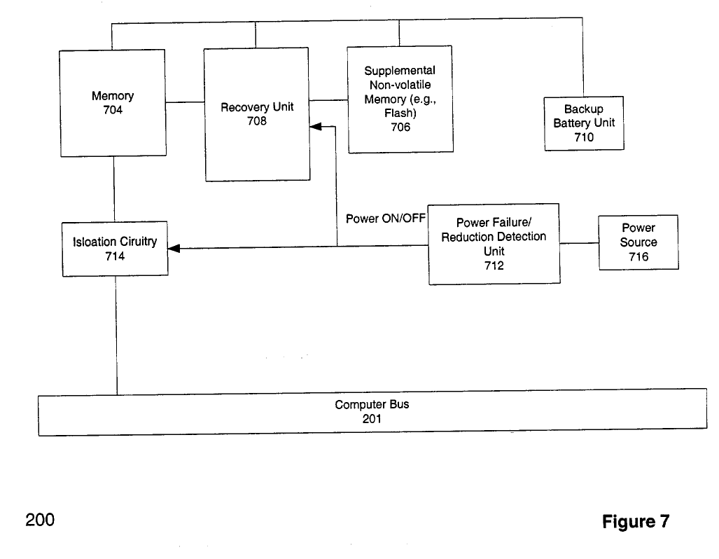

FIG. 7 is a block diagram conceptually illustrating memory backup and content preservation, according to one embodiment. As illustrated, computer system (system) 200 may include a computer bus 201 coupled with a memory 704 via an isolation circuitry 714. In other words, the isolation circuitry 714, which may be an independent circuitry or on the chipset, coupled with the memory 704 and the computer bus 201.

The memory 704, according to one embodiment, may include any variation of memory sets, memory apparatus, memory systems, memory mechanisms, on the memory platform, such as a random access memory (RAM), a dynamic Random Access Memory (DRAM), a synchronous DRAM (SDRAM), a double date rate SDRAM (DDR DRAM), a double-speed DRAM (DSDRAM), a DDR, a DDR2, a RAMBUS, or such, or a combination thereof. The computer system 200 further includes a recovery unit 708 coupled with the memory 704 and a supplemental memory 706, which may include a non-volatile flash memory. The system 200 further includes a power failure/reduction detection unit 712 for detecting from the power source 716 a power failure or reduction. The system 200 further includes a backup battery unit 710 for providing power in case of a power shutdown or reduction. According to one embodiment, the backup battery unit 710 may be a capacitor, a laptop-type battery, or a standalone battery, or such, or a combination thereof.

According to one embodiment, when the power from the main power source 716 of the computer system 200 may be lost or reduced to below a threshold level, power failure/reduction detection unit 712 may detect such power fluctuation and issue and mark power failure and inform the isolation circuitry 714 and/or the recovery unit 708 by providing a signal indicating the loss of or reduction in power. The power failure/reduction detection unit 712 may be coupled with the recovery unit 708 and/or the isolation circuitry 714 and the power source 716. Furthermore, in response to the signal indicating power failure or reduction, the isolation circuitry 714 may isolate the memory 704 from the computer bus 201.

In response to the signal, the backup battery unit 710 may be enabled and may take over from the main power source 716 to provide necessary power to various important components, such as the memory 704, components relating to the recovery unit 708, the supplemental memory 706, and such. According to one embodiment, the recovery unit 708 may selectively copy data from the memory 704 to a supplemental non-volatile memory 706 to ensure preservation of the data. Selectively copying of the data may include copying all of the data or only the data of interest, which may be all, none, or a portion of the data.

According to one embodiment, if no data is to be copied, the battery back unit 710 may be turned off to avoid unnecessary drain and power use. Similarly, once the data is copied from the memory 704 to the supplemental memory 706, the power from the backup battery unit 710 is turned off to avoid unnecessary drain and power use. According to one embodiment, multiple backup battery units and supplemental memory mediums are contemplated to satisfy the necessities and/or requirements of the computer system, users, and organization with varying capabilities and needs, as well as to provide a more complete memory backup and content preservation method, apparatus, and system.

According to one embodiment, for example, a flash memory may be used as a supplemental non-volatile memory 706 to provide the hybrid support to the memory 704 of the system 200. Since power failure is not expected too often, the support from the supplemental memory 706 is also not expected too often, and hence, even a supplemental memory with only limited life term or cycles is expected to last long enough to serve as a supplemental medium of storage.

According to one embodiment, for example, copying to a flash 706 from a DRAM 704 may help preserve all the performance characteristics of the DRAM 704 while having non-volatile aspects of a flash memory 706. According to one embodiment, copying only the critical portions of the memory 704 may constitute a need for only a potentially smaller and inexpensive supplemental memory 706.

According to one embodiment, any combination of the various components of the computer system 200 is contemplated, and may be used based on given circumstances, capabilities, and/or predetermined criteria. It is also contemplated that not all the components are necessary, and several other components may be added, as it will be obvious to the one familiar with the art.

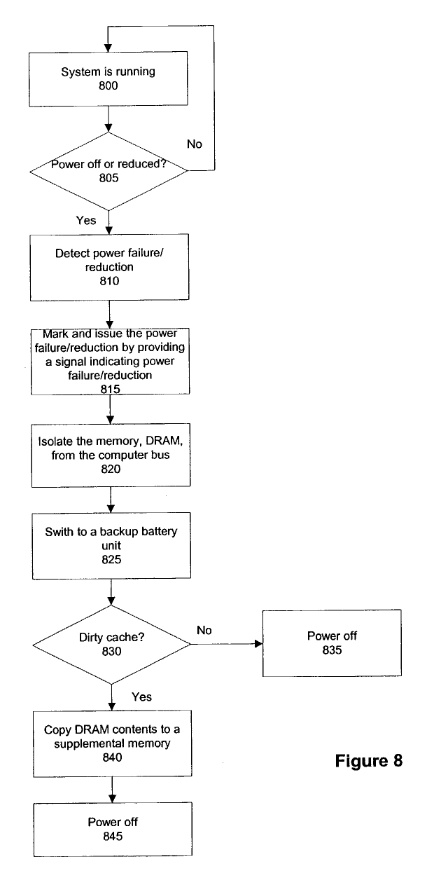

FIG. 8 is a flow diagram conceptually illustrating memory backup and content preservation, according to one embodiment. Prior to performing memory backup and content preservation, it may be determined whether the computer system is running. If the computer system is not running, there may not be a need for, for example, booting or to detect power off/reduction or to switch to a backup power source. First, the system is running at processing block 800.

At decision block 805, it is determined whether the power is on or off or reduced to under a threshold level. If it is detected that the power is on, the computer system functions as normal. According to one embodiment, if the power is off or it is reduced to below an acceptable level, such power failure or reduction is detected by a power failure/reduction detection unit at processing block 810. The power failure/reduction detection unit detects and marks the power failure or reduction and issues a signal indicating the power failure/reduction to the isolation circuitry and/or the recovery unit at processing block 815. The isolation circuitry, which may be an independent circuitry or on the chipset, may isolate the memory, such as dynamic random access memory (DRAM), from the computer bus at processing block 820. A backup battery unit is enabled and serves as a substitute/backup power source to the main power source at processing block 825.

At decision block 825, it is determined whether there is dirty cache. According to one embodiment, if no dirty cache is determined, power is turned off, i.e., the backup battery unit is turned off to avoid unnecessary battery drain and use of power at processing block 835. However, if dirty cache is determined, according to one embodiment, the data from the memory, such as DRAM, is selectively copied to the supplemental memory, such as a non-volatile flash, for preservation at processing block 840. According to one embodiment, the data of interest, which may be all of the data, none of the data, or portions of the data, may be copied from the memory, DRAM, to the supplemental memory. Once the data is copied to the supplemental non-volatile memory, the power is turned off at processing block 845.

In the foregoing specification, the present invention has been described with reference to specific embodiments thereof. It will, however, be evident that various modifications and changes may be made thereto without departing from the broader spirit and scope of embodiment of the present invention. The specification and drawings are, accordingly, to be regarded in an illustrative rather than a restrictive sense.

1. An apparatus, comprising:
a memory coupled to a computer bus, the memory having a first memory bank reserved for a private use;
an isolation circuitry coupled to the first memory bank to isolate the first memory bank from the computer bus in response to a signal indicating power failure; and
a power failure/reduction detection unit coupled to the isolation circuitry to detect the power failure and provide the signal to the isolation circuitry.

2. The apparatus of claim 1, further comprising:
a power source to provide power;
the memory having a second memory bank for operating system use; and
a backup power source coupled to the first memory bank, the backup power source to provide power upon switching of the first memory bank from the power source to the backup power source.

3. The apparatus of claim 1, wherein the private use comprises using the first memory bank to store to one or more of the following: a disk drive, a network, and an input/output (I/O) device.

4. The apparatus of claim 1, wherein the power failure comprises a reduction in power to below an acceptable threshold level of power, the acceptable threshold level of power as determined by necessities, capabilities, expectations, or a predetermined policy and/or criteria.

5. A method, comprising:
reserving a first memory bank of a memory coupled to a computer bus for a private use;
isolating the first memory bank from the computer bus in response to a signal indicating power failure; and
detecting the power failure and providing the signal indicating the power failure.

6. The method of claim 5, further comprising switching the first memory bank from a power source to a backup power source in response to the signal.

7. The method of claim 5, further comprises setting a cache dirty bit to selectively preserve data of interest on the first memory bank.

8. The method of claim 5, wherein the private use comprises storing or caching data to or from one or more of the following: a disk drive, a network, and an input/output (I/O) device.

9. An apparatus, comprising:
a recovery unit;
a memory coupled to a computer bus;
a supplemental memory coupled to the recovery unit, wherein the supplemental memory includes a non-volatile memory;
an isolation circuitry to isolate the memory from the computer bus in response to a signal indicating power failure; and
a power failure/reduction detection unit coupled to the isolation circuitry to detect the power failure and provide the signal to the isolation circuitry.

10. The apparatus of claim 9, further comprising:
the recovery unit coupled to the memory and the supplemental memory, the recovery unit to selectively copy data of the memory to the supplemental memory;
the power source to provide power; and
a backup battery unit to provide backup power to the memory, the supplemental memory, and the recovery unit in response to the signal.

11. The apparatus of claim 9, wherein the memory comprises a random access memory (RAM) or a dynamic random access memory (DRAM).

12. The apparatus of claim 9, wherein the supplemental memory comprises a non-volatile supplement memory including a flash memory.

13. A method, comprising:
receiving a signal indicating a power failure;
switching a memory and a supplemental memory from a power source to a backup battery unit, wherein the supplemental memory includes a non-volatile memory;
selectively copying data from the memory to the supplemental memory; and
turning off the backup battery unit.

14. The method of claim 13, further comprises isolating the memory from a computer bus in response to the signal.

15. The method of claim 13, wherein selectively copying comprises copying the data of interest.

16. A method, comprising:
detecting a memory bank of a memory to be reserved for a private use,
marking the memory bank as reserved;
loading a driver and allocating memory resources to the memory bank; and
reserving the memory bank for the private use.

17. The method of claim 16, wherein the private use comprises storing memory data to one or more of the following: a disk drive, a network, and an input/output (I/O) device.

18. The method of claim 16, further comprises defining and assigning hardware identification corresponding to the memory bank.

19. A system, comprising:
a dynamic random access memory (DRAM) coupled to a computer bus, the DRAM having a first DRAM dual in-line memory module (DIMM) reserved for a private use;
an isolation circuitry coupled to the first DRAM DIMM to isolate the first DRAM DIMM from the computer bus in response to a signal indicating power failure; and
a power failure/reduction detection unit coupled to the isolation circuitry to detect the power failure and provide the signal to the isolation circuitry.

20. The system of claim 19, further comprising:
a power source to provide power;
the DRAM having a second DRAM DIMM for operating system use; and
a backup power source coupled to the first DRAM DIMM, the backup power source to provide power upon switching of the first DRAM DIMM from the power source to the backup power source.

21. The system of claim 19, wherein the private use comprises using the first DRAM DIMM to store or cache data to or from a disk drive, a network, or an input/output (I/O) device.

22. A machine-readable medium having stored thereon data representing sets of instructions which, when executed by a machine, cause the machine to:
reserve a first memory bank of a memory coupled to a computer bus for a private use;
isolate the first memory bank from the computer bus in response to a signal indicating power failure; and
detect the power failure and providing the signal indicating the power failure.

23. The machine-readable medium of claim 22, wherein the sets of instructions which, when executed by the machine, further cause the machine to switch the first memory bank from a power source to a backup power source in response to the signal.

24. The machine-readable medium of claim 22, wherein the sets of instructions which, when executed by the machine, further cause the machine to put the first memory bank into a self-refresh mode.

25. A machine-readable medium having stored thereon data representing sets of instructions which, when executed by a machine, cause the machine to:
receive a signal indicating a power failure;
switch a memory and a supplemental memory from a power source to a backup battery unit, wherein the supplemental memory includes a non-volatile memory;
selectively copy data from the memory to the supplemental memory; and
turn off the backup battery unit.

26. The machine-readable medium of claim 25, wherein the sets of instructions which, when executed by the machine, further cause the machine to isolate the memory from a computer bus in response to the signal.

27. The machine-readable medium of claim 25, wherein to selectively copy comprises to copy the data of interest.

28. A machine-readable medium having stored thereon data representing sets of instructions which, when executed by a machine, cause the machine to:
detect a memory bank of a memory to be reserved for a private use;
mark the memory bank as reserved;
load a driver and allocate memory resources to the memory bank; and
reserve the memory bank for the private use.

29. The machine-readable medium of claim 28, wherein the private use comprises to store memory data to one or more of the following: a disk drive, a network, and an input/output (I/O) device.

30. The machine-readable medium of claim 28, wherein the sets of instructions which, when executed by the machine, further cause the machine to define and assign hardware identification corresponding to the memory bank.
